(19) United States
(12) Patent Application Publication
(10) Pub. No.: US 2025/0336251 A1
(43) Pub. Date: Oct. 30, 2025

(54) ACCESS CONTROL SYSTEM WITH BARRIER-FREE ACCESS

(71) Applicant: Inventio AG, Hergiswil (CH)

(72) Inventor: Tobias Friedli, Neuenhof (CH)

(21) Appl. No.: 18/869,769

(22) PCT Filed: Jun. 7, 2023
(86) PCT No.: PCT/EP2023/065170

§ 371 Date: Nov. 26, 2024

(30) Foreign Application Priority Data
Jun. 30, 2022 (EP) 22182134.1

(51) Int. Cl. G07C 9/25; G06V 40/16

(52) U.S. Cl. CPC G07C 9/253; G06V 40/161

(57) ABSTRACT

A system for controlling access to a restricted-access zone in a building or on a site comprises an access control device and a barrier-free lock. The lock comprises a display device, a recording device and an image recording device. Operating the system comprises activating the display device to display image data of a person generated by the image recording device as a real-time image visible to the person. The image recording device generates the image data when the person is at the lock to enter the restricted-access zone. The access control device checks whether a valid credential is identified. If a valid credential is identified, an approval signal is generated by the access control device and the display device displays that access has been approved. If a valid credential is not identified, an alarm message is generated by the access control device and the display device displays the alarm.

### TECHNICAL FIELD

The present disclosure generally relates to an access control system that grants an authorized user access to an access-restricted zone in a building or site. Embodiments of the disclosure relate in particular to an access control system comprising a barrier-free lock device and to a method for operating such an access control system.

### SUMMARY

Access control systems can be designed in a variety of different ways to control access to a restricted-access zone, e.g., in a building or on a site. For example, the way in which people must identify themselves as being authorized to enter, for example, with a key, a magnetic card, a chip card or an RFID card or with a mobile electronic device (for example a mobile phone), may vary. WO 2010/112586 A1 describes an access control system in which a person has to hold an optical code displayed by the person's mobile phone in front of a camera. If the code is valid, the person is granted access. Some access control systems may differ, for example, as to the way in which persons are granted or denied access to the building or to internal spaces at a (access control) lock. For example, doors, revolving doors or boom barriers are examples of barriers that are blocked or released (e.g., for example, unlocked or unblocked) on the basis of access being enabled and can be used in such a lock.

US 2014/0015978 A1 describes an access control system that does not require such a barrier and is therefore referred to as a barrier-free lock. The passage is open and barrier-free such that a person can, in principle, freely pass through the lock without delays and without hindrance. To control the passage, a recording device for checking a credential (in particular the payment of a fare) is arranged at the passage. Additionally, there is an image recording apparatus that records at least a portion of each person's face as they approach the recording device. From the combination of information from the credential and image information, a person who has not paid the fare can be determined and identified by an inspector. The inspector is shown the image information on their mobile device.

Such a barrier-free lock reduces the risk of delays or traffic jams at a lock with high traffic of people. However, persons who may inadvertently fail to provide a credential may find it disruptive to be publicly checked by the inspector. There is therefore a need for technology that offers the advantages of a barrier-free lock while still being user-friendly.

One embodiment of the present disclosure can relate to a method of operating a system for controlling access to a restricted-access zone in a building or on a site. The system can comprise an access control device and a barrier-free lock at an entrance to the restricted-access zone. The lock can be communicatively connected to the access control device and can comprise a display device, a detection device and an image recording device. The method can comprise activating the display device to display image data of a person generated by the image recording device as a real-time image that is visible to the person. The image recording device can generate the image data when the person is present at the lock in order to enter the restricted-access zone. The access control device can check whether the recording device detects a credential and whether the credential detected by the recording device is valid. If a valid credential is identified for the person, an approval signal can be generated by the access control device and the display device can be activated to display that access has been approved in addition to the real-time image. If a valid credential is not identified for the person, an alarm message can be generated by the access control device and the display device can be activated to display the alarm message in addition to the real-time image.

In another embodiment, the disclosure can relate to a system for controlling access to a restricted-access zone in a building or on a site. The system can have an access control device and a barrier-free lock at an entrance to the restricted-access zone. The lock can be communicatively connected to the access control device and can comprise a display device, a detection device and an image recording device. The display device can be configured to display image data of a person, which can be generated by the image recording device as a real-time image that is visible to the person. The recording device can be configured to detect a credential for the person. The image recording device can be configured to generate the image data when the person is present at the lock in order to enter the restricted-access zone. The access control device can be configured to check whether the recording device detects a credential and whether the credential detected by the recording device is valid. If the person provides a valid credential, the access control device can generate an approval signal and can activate the display device to display that access has been approved in addition to the real-time image. If the person does not provide a valid credential, the access control device can generate an alarm message and can activate the display device to display the alarm message in addition to the real-time image.

The present disclosure can make it possible to control access to a restricted-access zone in a user-friendly manner while ensuring a high level of security. The lock can be barrier-free, which can reduce the risk of delays or traffic jams when there is a high volume of people. In addition, a real-time image of the person, in particular the face of the person seeking access to the restricted-access zone, can be displayed at the lock. Displaying their own face in the real-time image can prompt or remind the person to present a credential. Real-time recording can allow the person to feel personally addressed, which can reduce the likelihood that the person will inadvertently pass through the lock without authenticating themselves. This can prevent a person with authorized access from triggering an alarm and being checked by an inspector even though they have simply forgotten to present their credential. Conversely, a person who wishes to enter the restricted-access zone without authorization may be deterred or prevented from doing so when they see their own face, for example, because they may assume that the image will be stored for evidence and identification purposes.

In some embodiments of the present disclosure, the real-time image can be displayed for the purposes described herein. The person's face can be detected in order to display it centrally in the real-time image. Known image processing methods carry out such facial detection in an extremely short amount of time, which allows for high throughput of people at the lock. A facial recognition method for authentication purposes that uses stored facial templates and possibly time-consuming comparison algorithms may not be used in conjunction with the display of the real-time image.

In one embodiment, the lock can be designed to detect the presence of the person at the lock and to activate the display device to generate an audible and/or visible cue for the person to identify themselves. The audible cue may comprise a voice message, and a visible cue may comprise displaying the voice message as text and/or an optical effect in conjunction with the real-time image. On its own or in combination with the optical effect. the voice message can also reduce said likelihood that the person will inadvertently pass through the lock without authenticating themselves. In addition, this may provide support to a person with restricted vision.

In an embodiment that can be used in conjunction with one or more of the embodiments described herein, the face of the person can be detected in the image data generated for the person, in particular, by the image recording device. The real-time image generated can substantially comprise the face of the person. Displaying the image such that it focuses on the face in particular can contribute to the advantages described herein of personally addressing and deterring the person.

In an embodiment that can be used in conjunction with one or more of the embodiments described herein, the prompt or reminder function described herein can be enhanced by the display device being designed to display, when activated accordingly, a full or partial border that substantially comprises an image region around the person's face. The display device can display the full or partial boundary according to one of a plurality of set optical effects. A first optical effect can prompt the person to identify themselves, a second optical effect can indicate that access has been approved and a third optical effect can indicate the alarm message. The type of optical effect can be selected for the building, for example in terms of color and/or temporal progression (e.g., continuous light, flashing or increasing and decreasing).

In one embodiment which may be applicable in conjunction with one or more of the preceding embodiments, the real-time image can be saved in a storage device for an operating mode if the alarm message is provided by the access control device. This may make it easier for a person to be identified by an inspector, for example, with more certainty.

In an embodiment that may be applicable in conjunction with one or more of the embodiments described herein. a camera system may be provided that can be communicatively connected to the access control device and can be arranged in particular in the restricted-access zone. The camera system can be configured to be activated when the alarm message is given. This can make it possible to track a person in the restricted-access zone. In particular, they can be better identified so that they can then be checked, for example.

In an embodiment that may be applicable in conjunction with one or more of the embodiments described herein. the access control device may be configured to generate an alarm signal when the alarm message is present and to send it to an elevator system. The elevator system can be configured to block an elevator service departing from the restricted-access zone in response to the alarm signal. If there is a security breach on the floor of the lock, this can prevent, for example, an unauthorized person from being able to use an elevator to reach another floor. In conjunction with said camera system, in one embodiment it can be possible to identify which of a plurality of elevators this person is entering or intends to enter. The identified elevator and/or a neighboring elevator can then be activated accordingly, e.g., closing of the elevator doors can be prevented.

In an embodiment that may be applicable in conjunction with one or more of the embodiments described herein, the identification device may be configured to record an optical code, a biometric feature and/or a radio signal. The credential can be recordable as an optical code, biometric feature or radio signal. The lock can be designed to identify one or more types of credentials. One or more types of credentials may therefore be intended for use in a building.

### BRIEF DESCRIPTION OF THE DRAWINGS

Various aspects of the disclosure are described in greater detail herein in conjunction with the drawings with reference to example embodiments. In the figures, identical elements have identical reference signs. In the drawings:

FIG. 1 is a schematic view of an application example of an access control system as part of a building system in a building;

FIG. 2 is a schematic view of an embodiment of an interaction between the access control system and a person with authorized access;

FIG. 3 is a schematic view of an embodiment of an interaction between the access control system and a person who does not have authorized access; and

FIG. 4 is a flowchart of an embodiment of a method for operating the access control system.

### DETAILED DESCRIPTION

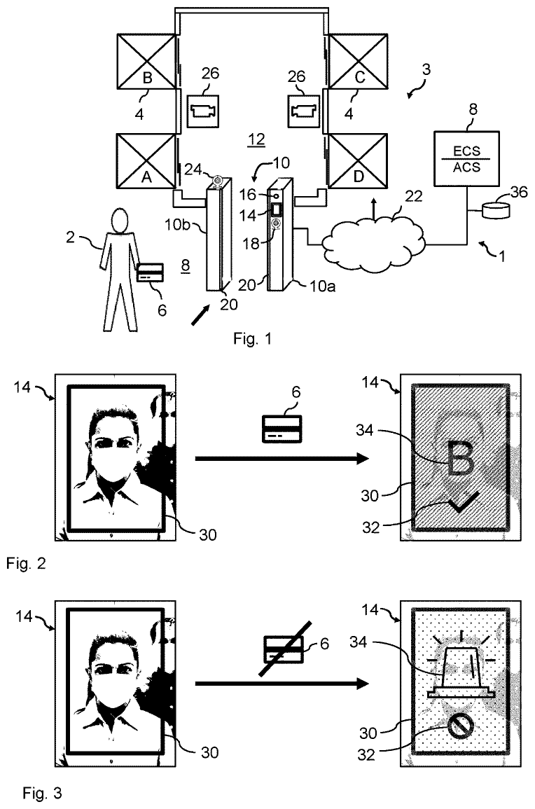

FIG. 1 is a schematic view of an embodiment of an access control system 1 as part of a building system in a building. For illustrative purposes, only some walls, rooms 4 and zones 8, 12 of the building are shown, as may exist in an example situation on one floor of the building. The rooms 4 may be, for example, offices, apartments, halls and/or elevator cars of an elevator system. In the embodiments described herein, the building system can comprise the access control system 1, which can comprise at least one lock 10, and an elevator system 3. The rooms 4 shown may belong to a group of elevators, which can comprise, for example, four elevators (A-D). Instead of the four elevators shown, the elevator system 3 can have a greater or fewer number of elevators. An elevator control device ECS can control the elevator system 3, and an access control device ACS can control the access control system 1. In FIG. 1, these control devices are combined in one control system 8 for illustration purposes, which control system is communicatively connected to the lock 10 and the elevators (A-D) and their devices via a communication network 22. A person skilled in the art recognizes that the access control device ACS and the elevator control device ECS can be arranged separately from one another in the building.

In the embodiment of the access control system 1 shown in FIG. 1, a person 2 carrying a credential 6 on them is located on the floor in zone 8. The zone 8 may not be access-restricted in this embodiment and is also referred to herein as public zone 8. The public zone 8 may be a region inside or outside the building. The lock 10 can separate the public zone 8 from the zone 12 which may be access-restricted and adjoins the rooms 4. The zone 12 can also be referred to hereinafter as non-public or restricted-access zone 8. A person skilled in the art will recognize that the access control system 1 may not be limited to applications within a building, but may be used in an analogous manner to also control access to an access-restricted zone on a site. The term “building” in this description can be understood to mean, for example, residential buildings, commercial buildings, sports arenas and shopping centers. The present disclosure can also be used on or in conjunction with a ship.

The access control system 1 can be configured to monitor access to the restricted-access zone 12 such that only authorized persons 2 can enter the zone 12. According to the present disclosure, access can be provided via the lock 10, which can be configured as a barrier-free lock 10. In FIG. 1, the lock 10 is represented by two structures 10a. 10b standing on the floor. with a passageway between the structures 10a, 10b through which the person 2 can walk in the direction of the arrow indicated if they wish to go from the zone 8 to the zone 12. A person skilled in the art recognizes that the lock 10 shown is an example. Depending on the building and/or expected volume of traffic, the lock 10 may comprise of a plurality of individual locks, each with passageways between two adjacent structures. A person skilled in the art will also recognize that the lock 10 can have a different design, for example, with only one structure instead of the two structures 10a, 10b shown in FIG. 1. A passageway can then exist, for example, between this structure and a wall of the building. The structure or at least one of its components described below can also be arranged on a wall of the building, in which case the passageway can then be in the region in front of the wall of the building or the components.

FIG. 1 shows the following components of the lock 10 by way of example: a display device 14 (e.g., comprising an LED or LCD display device), a recording device 16 for recording a credential 6 and an image recording device 18 (e.g., a camera). These components (14, 16, 18) can be arranged by way of example on or in the (right-hand) structure 10a, but are not limited to this arrangement. For illustration purposes, the components (14, 16, 18) are shown on a front side of the structure 10a. A person skilled in the art recognizes that at least one of the components (14, 16, 18) can be arranged on another side of the structure 10a, in particular on a top side.

In one embodiment, a sensor device 24 can be arranged on or near the lock 10. In FIG. 1, the sensor device 24 is arranged by way of example on the (left-hand) structure 10b. but is not limited to this arrangement. The sensor device 24 can be coonfigured and accordingly arranged to detect the passage of the person 2 through the lock 10. The sensor device 24 can comprise a camera (2D or 3D camera), a 3D sensor (e.g., a time-of-flight (ToF) sensor), a light barrier or another sensor suitable for detecting persons or objects.

The image recording device 18 can be configured and arranged accordingly on the lock 10 to record a defined field of view in the region of the lock 10. The image recording device 18 can generate a camera image of at least part of the person 2 located at the lock 10, in particular the face or part thereof, and can transmit the camera image to the display device 14. Methods and devices for detecting a face in an image or in image data, e.g., for identifying where in the image the face is located, are known to a person skilled in the art, e.g., from Rein-Lien Hsu et al., “Face detection in color images,” IEEE Transactions on Pattern Analysis and Machine Intelligence, vol. 24. no. 5. May 2002. pp. 696-706.

The display device 14 can display the recorded part, for example the (entire) face, visibly to the person 2, for example, substantially within a full or partial boundary 30. The display device 14 can be arranged on the lock 10. An example display function of the display device 14 is shown in FIG. 2 and FIG. 3 each time in the left-hand part of the drawing, wherein the full or partial boundary 30 is shown as a rectangular frame which substantially comprises an image region around the face of the person 2. The display device 14 can control the display of the full or partial boundary 30 according to a first optical effect that can prompt the person 2 to identify themselves, a second optical effect that can indicate that access has been approved, and a third optical effect that can indicate an alarm message.

Depending on the design of the lock 10, a signaling device 20 may be present, which can be arranged at least in or on one of the two structures 10a.,10b. In FIG. 1, both structures 10a, 10b are equipped with the signaling device 20, wherein the signaling device 20 is provided, by way of example, along a vertical edge of the structure 10a, 10b. In one embodiment, the signaling device 20 can be configured and accordingly arranged on the lock 10 to generate light of different colors (e.g., red and green) and/or an acoustic signal (e.g., an alarm signal), wherein the light and/or the acoustic signal may each be perceptible to the person 2. A person skilled in the art recognizes that the signaling device 20 can have a different design as long as it or its signals is/are perceptible to the person 2.

The access control system 1 shown in FIG. 1 can comprise one or more camera systems 26 which can be arranged in the region of the lock 10, in particular in the restricted-access zone 12. In one embodiment, such a camera system 26 can be configured to detect. either on its own or in conjunction with the sensor device 24, the person 2 and to track their movement within the zone 12. A person skilled in the art recognizes that the number of camera systems 26 and their spatial arrangements can be adapted to the building and/or to the size of the zone 12. A person skilled in the art will also recognize that the camera system(s) 26 are optional, for example, if no tracking is provided. Such a camera system 26 is known to a person skilled in the art. Such a camera system 26 can comprise, for example, a 2D or 3D video camera. each with an associated image processing device. For example. EP 1 345 445 A1 discloses, in conjunction with an elevator system, a 3D camera or a sensor device for recording three dimensions in order to record the positions of persons or other objects, the distances therebetween and their movements and directions of movement.

The identification device 16 can have different designs, in particular, it can be designed for one or more types of credentials 6. In the building system, a credential 6 can be assigned to a person 2 or group of people (e.g., in a database for user profiles), which may be, in particular, consciously presented by the person 2 at the entrance to the restricted-access zone 12. The credential 6 can be stored as a password (code) on an information carrier (e.g., in a chip of a chip card or a magnetic stripe of a magnetic stripe card) or depicted (e.g., as an optical code in the form of a QR code, a bar code or a color code). In one embodiment, the credential 6 may be a biometric feature, e.g., a face, voice, finger or eye pattern of the person 2.

The identification device 16 can be adapted to the credential(s) 6 to be used in the building. In one embodiment, the identification device 16 may comprise an optical reading device (e.g., a digital camera) to record, for example, an optical code from an information carrier. The information carrier can be designed, for example, in the form of a credit card-shaped employee ID card or the like. In another embodiment, a mobile phone (or a similar electronic device) of the person 2, which displays the optical code on a display, can serve as the information carrier. In one embodiment. the digital camera of the optical reading device (or an additional digital camera) can be used to record a biometric credential 6. The recorded biometric credential 6 can then be used in conjunction with an identification device and biometric data stored for persons 2 registered in the building to determine that access is approved, e.g., with facial recognition.

Additionally or alternatively, a radio-based reading device may be provided, which can read the credential 6 from a chip of an RFID transponder, for example. An employee ID card or the like or a mobile phone can serve as an RFID transponder, for example. In one embodiment, the radio-based reading device can be designed for communication with the mobile phone or the like according to near-field communication (NFC) or Bluetooth technology.

In the embodiments disclosed herein, the credential 6 may be presented. A person skilled in the art recognizes that the credential 6 can represent the information used to check the access authorization proof, specifically irrespective of the type of information (code or biometric feature) and the design of any information carrier. The drawings show, for example, a card-shaped information carrier on which the credential 6 is stored or displayed. The information carrier can therefore also be referred to as a credential 6.

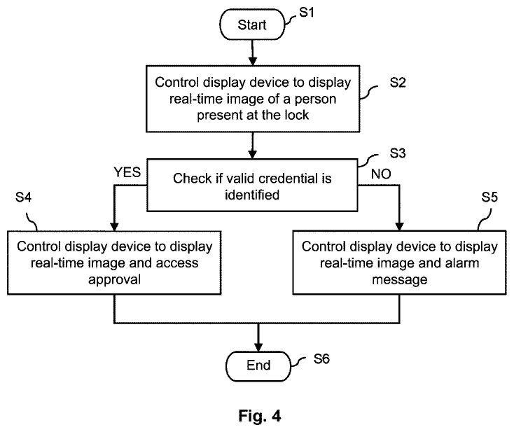

In the situation in the building shown in FIG. 1, the features of the present disclosure can be advantageously used. Further comments regarding embodiments of the access system 1 and the elevator system 3 are provided herein. In relation to the embodiment shown in FIG. 1 and with the understanding of the components described herein and their functionalities in the access control system 1, an example access control method will be described below in conjunction with FIG. 4. The description is given with reference to the person 2, who wants to go from zone 8 to the restricted-access zone 12 at the lock 10, for example, to use an elevator (A-D) located there. The person 2 may carry a credential 6 on them, which is designed here, for example, as shown in FIG. 1, as a credit card-shaped employee ID card. The credential 6 may be presented at the lock 10 in order to enter the restricted-access zone 12. The access control system 1 may be activated. The method begins with a step S1 and ends with a step S6. A person skilled in the art recognizes that the division into these steps is an example, that additional steps can be provided and that one or more of these steps can be divided into one or more sub-steps, or that a plurality of the steps can be combined into one step.

If the person 2 moves in the direction of the arrow shown in FIG. 1 in order to enter the restricted-access zone 12 on the floor, they may enter the field of view of the image recording device 18 at or in the region of the lock 10. The resulting presence of the person 2 at the lock 10 may cause the image recording device 18 to generate image data. In a step S2, the display device 14 may be activated to display image data of the person 2 generated by the image recording device 18 as a real-time image visible to the person 2. An example real-time image with the face of the person 2 is shown in FIG. 2 and FIG. 3 (on the left in both).

In one embodiment, when the presence of the person 2 at the lock 10 is detected. the display device 14 may be activated to generate an audible and/or visible cue for the person 2 to identify themselves. The audible cue may comprise a voice message, and the visible cue may include displaying the voice message and/or an optical effect in conjunction with the real-time image.

In a step S3, the access control device ACS may check whether a valid credential 6 is identified for the person 2. As mentioned herein, the person 2 may identify themselves at the barrier-free lock 10, in particular, by presenting the credential 6 at the identification device 16. If the person 2 knows of this requirement, they may identify themselves. They may also be asked to identify themselves and in some cases may be reminded to do so. In one embodiment, this may be done, or at least assisted, by the display device 14 displaying the real-time image of the face of the person 2 so that the person 2 can see the displayed image when they are at the lock 10. The real-time image may display a prompt for identification and/or it may be accompanied by a corresponding voice message. In addition, the full or partial boundary 30 (frame) can be highlighted optically (e.g., in color and/or with a light effect (e.g., flashing or increasing and decreasing)).

If the person 2 has identified themselves, e.g., by presenting a valid credential 6, the method can proceed along the “yes” branch to a step S4. In step S4, if the credential is valid, an approval signal may be generated by the access control device ACS and the display device 14 may be activated to display that access has been approved in addition to the real-time image. In the embodiment shown in FIG. 2, the display device 14 may indicate that access is granted, for example, with a symbol 32 and/or by optically highlighting the full or partial boundary 30. e.g., it can be shown glowing green (constantly or flashing). In addition, the signaling device 20 can be activated and light up green, for example. Therefore, the person 2 and an inspector that may be present can see that they have been granted access. The method ends in step S6.

If, however, a valid credential 6 is not identified for the person 2 because the person does not present any credentials or any valid credentials 6, the method can proceed along the “No” branch to a step S5. In step S5, an alarm message may be generated by the access control device ACS and the display device 14 may be activated to display the alarm message in addition to the real-time image. In the embodiment shown in FIG. 3, the display device 14 may display the face of the person analogously to FIG. 2 but the symbol 32 and/or the color highlighting of the full or partial boundary 30 (e.g., it may light up red) may now represent a warning or an alarm. Depending on the design, a text, a word and/or an alarm symbol can be displayed in a display region 34. In addition, the signaling device 20 can be activated and, for example, light up red. Therefore, the person 2 and an inspector that may be present can see that they have not been granted access in some cases.

If the person 2 has forgotten to present their credential 6 they can do so in response to the warning without being asked to do so by an inspector. For example, the person 2 can go back and present their credential 6. Since the person 2 may be authorized access in such a case. this method may be more pleasant than a check for the person 2 when in public. If, however, the person 2 is not authorized access and still tries to go through the lock 10. the inspector can identify them using the face displayed and, for example, carry out a check and/or another measure. For this purpose, the real-time image can be stored for a specified period of time, e.g., in the storage device 36. The method ends at step S6.

If the person 2 moves in the direction of the arrow shown in FIG. 1 and presents their valid credential 6 to the recording device 16. this means that, in the situation shown, the person 2 may want to be transported to a desired destination floor by one of the elevators (A-D). The destination floor can be stored in a user profile of a building management system of the building system generated for the person 2. The elevator control device ECS can. for example, be designed as a group control device with destination call control technology. When the person 2 is identified, for example, a destination call may be initiated which specifies the destination floor stored in the user profile of the person 2 and the floor on which the lock 10 is located as the boarding floor. For example, if the access control takes place in an entrance hall of the building through which the persons 2 must pass in order to arrive at the elevators A-D, a destination call may be initiated each time access is granted to the person 2 in question. The elevator control device ECS may determine an elevator to serve the destination call and informs the person 2 of the determined elevator. for example, with the display device 14 at the lock 10. If there are a plurality of locks 10, such a display device 14 can be provided at each lock 10. The access control system I may identify which lock 10 the person 2 is at and may activate the display device 14 arranged there to display the assigned elevator in the display region 34 (e.g., “B,” FIG. 2). A person skilled in the art recognizes that the display device 14 can be designed to generate a corresponding voice message.

In conjunction with the elevator system 3, the alarm message generated in step S5 may be transmitted as an alarm signal to the elevator control device ECS. The elevator control device ECS can be configured to carry out one or more specified measures in response to a security breach indicated by the alarm signal. According to a defined measure, the elevator control device ECS can, for example, block an elevator service departing from the restricted-access zone 12 so that no elevators A-D depart or stop or no elevator doors open or close on the floor of the restricted-access zone 12, for example. Depending on the building, elevator system 3 and the circumstances of the security breach, one of a plurality of elevators or the entire elevator system 3 may be taken out of service. A measure taken may remain in place until the security breach is under control. Said storage of the real-time image may also be limited to this period of time.

In one embodiment, the camera system 26 can be used to track the person 2 in the event of a security breach. In the situation shown in FIG. 1, the camera 24 can identify that the person 2 is passing through the lock 10, and the camera system 24 may determine the path of the person 2. The determination of the path can be used to identify in which direction and/or to which elevator A-D the person 2 is walking or which elevator A-D the person 2 is getting into. The measure taken can block the elevator that the person 2 is approaching or has already entered, for example.

A user profile can be created for each person 2 registered in the building system, e.g., it can be stored as a data record in a database. In one embodiment, the database can be set up in a storage device 36 of the building system. In FIG. 1, the storage device 36 is coupled to the communication network 22, but a person skilled in the art recognizes that it or its storage function can be implemented in a different way. For example, the storage device 36 can be implemented in the lock 10, the elevator control device ECS or the access control device ACS.

The user profile can comprise personal data of the person 2 (e.g., name, reason for authorization (resident, employee, external service provider, visitor)), access authorizations (e.g., certain rooms 4 and floors) and any temporal access restrictions (e.g., access from Monday to Friday, from 7:00 a.m. to 8:00 p.m.). As an alternative to creating the user profile in the building system. the user profile may be created in a database of a remote building management system, it being possible for the access control system 1 to access this database using the Internet and/or cloud computing technology.

As shown in FIG. 1, the lock 10 can comprise the image recording device 18, which can generate an image recording of the person 2 (in particular the face) located in the recording region of the image recording device 18 when the person 2 wishes to enter the restricted-access zone 12. In one embodiment, the image recording device 18 can comprise a digital camera with selectable and/or settable properties. In said embodiment, camera images may therefore be available as digital data records (digital camera images (also called a digital image)). The properties of the digital camera. for example, resolution (for example, indicated in megapixels), exposure and focal length, may be selected or set so that a camera image (digital image) may be evaluated and the face of the person 2 may be recognized in recognizable quality in the digital image. The digital image can be, for example, in a JPEG format, but it may also be in a different format, for example, in the BMP format or in the JPEG2000 format.

In one embodiment, the display device 14 can display the digital image for a fixed period of time, for example, for the duration that the person 2 is present at the lock 10. During this time, the person 2 may present the credential 6 (in some cases following a request as mentioned above), whereupon the access authorization may be checked and the inspector may identify the person 2 and take action if necessary. After this period of time, the display of the digital image may be deleted without storing the digital image in the building system or assigning it to the person 2. This can make it possible to meet any existing legal data protection requirements.

The image recording device 18 may be equipped with a sensor module or may be connected to a separate sensor module, which can activate the image recording device 18 when it detects the presence of a person 2 in the recording region. The sensor module may comprise, for example, a proximity sensor, which may be designed as an ultrasonic sensor, an infrared sensor or an optical sensor (for example, light barrier, brightness sensor).

Alternatively, in one embodiment the presence of a person 2 in the recording region of the image recording device 18 may be identified as a result of changes detected in the recording region. If, for example, the person 2 enters the recording region and the image recording device 18 is always in an active state, the image recording device 18 may record changes in front of a substantially static background. These changes can be interpreted as the person's presence.

1-15. (canceled)

16. A method for operating a system for controlling access to a restricted-access zone in a building or on a site, wherein the system comprises an access control device and a barrier-free lock at an entrance to the restricted-access zone, wherein the barrier-free lock is communicatively connected to the access control device and comprises a display device, a recording device and an image recording device, the method comprising:
activating the display device to display image data of a person generated by the image recording device as a real-time image visible to the person, wherein the image recording device generates the image data when the person is present at the barrier-free lock in order to enter the restricted-access zone;
checking, with the access control device, whether a credential is recorded by the recording device and whether the credential recorded by the recording device is valid;
if a valid credential is identified for the person, generating an approval signal with the access control device and activating the display device to display that access has been approved in addition to the real-time image;
if a valid credential is not identified for the person, generating an alarm message with the access control device and activating the display device to display the alarm message in addition to the real-time image.

17. The method of claim 16, further comprising detecting a presence of the person at the barrier-free lock and actuating the display device to generate at least one of an audible cue or visible cue for the person to identify themselves, wherein the audible cue comprises a voice message and wherein the visible cue comprises at least one of displaying the voice message as text or displaying an optical effect in conjunction with the real-time image.

18. The method of claim 16, further comprising detecting a face of the person in the image data generated for the person and generating the real-time image that comprises the face of the person.

19. The method of claim 17, further comprising detecting a face of the person in the image data generated for the person and generating the real-time image that comprises the face of the person.

20. The method of claim 18, further comprising actuating the display device to display a full or partial boundary which comprises an image region around the face of the person.

21. The method of claim 19, further comprising actuating the display device to display a full or partial boundary which comprises an image region around the face of the person.

22. The method of claim 20, wherein the display device displays in a display region of the full or partial boundary at least one of a first optical effect, which prompts the person to identify themselves, a second optical effect, which indicates that access has been approved, or a third optical effect, which indicates the alarm message.

23. The method of claim 16, further comprising storing the real-time image in a storage device with the access control device when the alarm message is provided.

24. The method of claim 17, further comprising storing the real-time image in a storage device with the access control device when the alarm message is provided.

25. The method of claim 16, further comprising activating a camera system with the access control device when the alarm message is issued in order to track the person in the restricted-access zone.

26. The method of claim 16, further comprising generating an alarm signal with the access control device when the alarm message is issued and sending the alarm signal to an elevator system in order to block an elevator service departing from the restricted-access zone.

27. A system for controlling access to a restricted-access zone in a building or on a site, the system comprising:
an access control device; and
a barrier-free lock at an entrance to the restricted-access zone, wherein the barrier-free lock is communicatively connected to the access control device and comprises a display device, a recording device and an image recording device,
wherein the display device is configured to display image data of a person generated by the image recording device as a real-time image visible to the person,
wherein the recording device is configured to record a credential of the person,
wherein the image recording device is configured to generate the image data when the person is present at the barrier-free lock in order to enter the restricted-access zone,
and wherein the access control device is configured to:
check whether the recording device records a credential and whether the credential recorded by the recording device is valid;
generate, if the person has a valid credential, an approval signal and to activate the display device to display that access has been approved in addition to the real-time image; and
generate, if the person does not have a valid credential, an alarm message and to activate the display device to display the alarm message in addition to the real-time image.

28. The system of claim 27, wherein the recording device is configured to record at least one of an optical code, a biometric feature or a radio signal, wherein the credential is recorded as at least one of an optical code, a biometric feature or a radio signal.

29. The system of claim 27, wherein the display device is configured to generate at least one of an audible cue or visible cue for the person to identify themselves, wherein the audible cue comprises a voice message and wherein the visible cue comprises displaying at least one of the voice message or an optical effect in conjunction with the real-time image.

30. The system of claim 28, wherein the display device is configured to generate at least one of an audible cue or visible cue for the person to identify themselves, wherein the audible cue comprises a voice message and wherein the visible cue comprises displaying at least one of the voice message or an optical effect in conjunction with the real-time image.

31. The system of claim 27, wherein the image recording device is configured to detect a face of the person in the image data generated for the person, and wherein the display device is configured to display the image data as a real-time image which comprises the face of the person.

32. The system of claim 28, wherein the image recording device is configured to detect a face of the person in the image data generated for the person, and wherein the display device is configured to display the image data as a real-time image which comprises the face of the person.

33. The system of claim 31, wherein the display device is configured to display a full or partial boundary which comprises an image region around the face of the person.

34. The system of claim 33, wherein the display device is configured to activate a first optical effect, which prompts the person to identify themselves, a second optical effect, which indicates that access has been approved, and a third optical effect, which indicates the alarm message, for a display region of the full or partial boundary.

35. The system of claim 27, further comprising a camera system which is communicatively connected to the access control device, wherein the camera system is configured to be activated when the alarm message is issued in order to track the person in the restricted-access zone.
